(19) United States
(12) Patent Application Publication
(10) Pub. No.: US 2008/0198348 A1
(43) Pub. Date: Aug. 21, 2008

(54) Apparatus and methods for minimizing force variation from immersion liquid in lithography systems

(75) Inventors: Alex Ka Tim Poon, San Ramon, CA (US); Leonard Wai Fung Kho, San Francisco, CA (US); Gaurav Keswani, Fremont, CA (US); Derek Coon, Redwood City, CA (US)

Correspondence Address: OLIFF & BERRIDGE, PLC, P.O. BOX 320850, ALEXANDRIA, VA, 22320-4850, US

(73) Assignee: NIKON CORPORATION, TOKYO (JP)

(21) Appl. No.: 12/068,737

(22) Filed: Feb. 11, 2008

Related U.S. Application Data
(60) Provisional application No. 60/902,105, filed on Feb. 20, 2007.
(60) Provisional application No. 60/996,818, filed on Dec. 6, 2007.

(51) Int. Cl. G03B 27/52

(52) U.S. Cl. 355/30

(57) ABSTRACT

A lithographic projection apparatus includes an optical assembly that projects an image onto a workpiece, and a containment member disposed adjacent to a lower end of the optical assembly. The containment member has an aperture through which an exposure beam passes from the optical assembly to the workpiece. The lithographic projection apparatus also includes a stage assembly including a workpiece table that supports the workpiece adjacent to the containment member. A space between the containment member and the workpiece is filled with an immersion liquid. The lithographic projection apparatus further includes a liquid collection system that has a recess in the workpiece table that receives immersion liquid that overflows the space between the containment member and the workpiece. At least part of the recess is disposed radially outward of the workpiece. The recess is partially filled with a porous material.

### CROSS-REFERENCE TO RELATED APPLICATION

This application claims the benefit of U.S. Provisional Patent Application Nos. 60/902,105 filed Feb. 20, 2007 and 60/996,818 filed Dec. 6, 2007. The disclosures of the provisional applications are incorporated herein by reference in their entireties.

### BACKGROUND

The invention relates to immersion lithography apparatus and methods, and particularly to apparatus and methods for minimizing and/or compensating for dynamic changes in the forces exerted on a workpiece stage by the immersion fluid in an immersion lithography system having a containment member.

A typical lithography apparatus includes a radiation source, a projection optical system and a substrate stage to support and move a substrate to be imaged. A radiation-sensitive material, such as a resist, is coated onto the substrate surface before the substrate is placed on the substrate stage. During operation, radiation energy from the radiation source is used to project an image defined by an imaging element through the projection optical system onto the substrate. The projection optical system typically includes a plurality of lenses. The lens or optical element closest to the substrate can be referred to as the last or final optical element.

The projection area during exposure is typically much smaller than the imaging surface of the substrate. The substrate therefore is moved relative to the projection optical system in order to pattern the entire surface of the substrate. In the semiconductor industry, two types of lithography apparatus are commonly used. With so-called “step-and-repeat” apparatus, the entire image pattern is projected at one moment in a single exposure onto a target area of the substrate. After the exposure, the substrate is moved or “stepped” in the X and/or Y direction(s) and a new target area is exposed. This step-and-repeat process is performed multiple times until the entire substrate surface is exposed. With scanning type lithography apparatus, the target area is exposed in a continuous or “scanning” motion. For example, when the image is projected by transmitting light through a reticle or mask, the reticle or mask is moved in one direction while the substrate is moved in either the same or the opposite direction during exposure of one target area. The substrate is then moved in the X and/or Y direction(s) to the next scanned target area. The process is repeated until all of the desired target areas on the substrate have been exposed.

Lithography apparatus are typically used to image or pattern semiconductor wafers and flat panel displays. The word “substrate” and “workpiece” as used herein is Intended to generically mean any workpiece that can be patterned including, but not limited to, semiconductor wafers and flat panel displays.

Immersion lithography is a technique that can enhance the resolution of lithography exposure apparatus by permitting exposure to take place with a numerical aperture (NA) that is greater than the NA that can be achieved in conventional “dry” lithography exposure apparatus. By filling the space between the final optical element of the projection system and the resist-coated substrate, immersion lithography permits exposure with light that would otherwise be internally reflected at the optic-air interface. Numerical apertures as high as the index of the immersion fluid (or of the resist or lens material, whichever is least) are possible in immersion lithography systems. Liquid immersion also increases the substrate depth-of-focus, that is, the tolerable error in the vertical position of the substrate, by the index of the immersion fluid compared to a dry system having the same numerical aperture. Immersion lithography thus can provide resolution enhancement without actually decreasing the exposure light wavelength. Thus, unlike a shift in the exposure light wavelength, the use of immersion would not require the development of new light sources, and can allow the use of the same or similar resists as conventional “dry” lithography at the same wavelength. In an immersion system in which the final optical element of the projection system and the substrate (and perhaps portions of the stage as well) are in contact with the immersion fluid, much of the technology and design developed for dry lithography can carry over directly to immersion lithography.

The pressure and forces exerted by the immersion fluid on the last optical element and wafer stage should be constant. This desired result, however, is very difficult to achieve for a number of reasons.

With immersion lithography, the fluid is constantly removed and replenished. The removal of the fluid helps recover any contaminants and heat generated during exposure. Ideally, the amount of fluid being supplied should equal the amount being removed. A precise equilibrium, however, is difficult to achieve in practice. An uneven flow rate, which may result in a varying volume of fluid under the last optical element, may cause the forces and pressures acting on the last optical element and wafer stage to be dynamic.

The movement of the wafer stage also creates dynamic forces on the last optical element due to the behavior of the immersion fluid. For example, when the wafer stage starts accelerating, the shape of the fluid at the fluid-air interface, sometimes called the meniscus, changes. The meniscus tends to extend outward at the leading edge and pull-in at the trailing edge of the movement. The change in the shape in the meniscus creates a change in the static pressure exerted on the last optical element and stage by the immersion fluid.

The motion of the stage also creates waves in the immersion fluid. These waves may cause the last optical element to oscillate up and down as well as perturb the wafer stage. If the oscillations are still occurring during an exposure due to the lingering effects of the waves, the accuracy and image quality may be adversely affected.

Vertical adjustments of the wafer may also cause the volume of the gap between the last optical element and the wafer to change. The surface of a wafer is not perfectly flat. Vertical adjustments are made by the wafer stage, depending on the surface topography of the wafer, to maintain the distance between the last optical element and the exposure area constant. The volume of the space between the wafer and last optical element changes when the wafer is moved up and down. As the volume changes, the pressure and forces of the immersion fluid acting on both the last optical element and the wafer stage also change.

The dynamic forces and pressures acting on the last optical element caused by the motion of the immersion fluid may cause the last optical element to become distorted and/or moved either up or down from its ideal position. As a result, the last optical element may be out of focus, resulting in a poor exposure. Similar forces acting on the wafer stage may affect its performance as well.

At high stage speeds the meniscus can be perturbed to the point where it breaks down, particularly at the leading edge. The breakdown is characterized by the escape and deposition of fluid droplets on the wafer where it emerges from the fluid. Such droplets are undesirable. They can entrap air, creating bubbles, when the wafer passes under the immersed lens on a subsequent scan. Also if the droplets dry on the wafer, any contaminants in the droplet, for example residues dissolved from the resist, remain deposited on the wafer.

### SUMMARY

In a lithography system using a containment member, such as a confinement plate, the amount of immersion fluid on the workpiece stage is much larger than in a conventional system using a local fill nozzle because the containment member is sufficiently large to submerge the entire imaging surface of the workpiece in the immersion fluid. A larger amount of immersion fluid on the workpiece stage causes a greater force on the workpiece due to the immersion fluid's larger mass and larger liquid meniscus.

An apparatus and method capable of minimizing and/or compensating for dynamic changes in the forces exerted on the workpiece stage by the larger mass and liquid meniscus of the immersion fluid caused by using a containment member is therefore needed.

Aspects of the invention minimize and/or compensate for force variation due to changes in the shape of the liquid meniscus, and/or avoid changes in the shape of the liquid meniscus, and thus improve position accuracy of the workpiece stage during exposure.

According to some aspects of the invention, a lithographic projection apparatus is provided that includes an optical assembly that projects an image onto a workpiece, and a containment member disposed adjacent to a lower end of the optical assembly. The containment member has an aperture through which an exposure beam passes from the optical assembly to the workpiece. The projection apparatus also includes a stage assembly including a workpiece table that supports the workpiece adjacent to the containment member. A space between the containment member and the workpiece is filled with an immersion liquid. The projection apparatus further includes a liquid collection system including a recess in the workpiece table and that receives immersion liquid that overflows the space between the containment member and the workpiece. At least part of the recess is disposed radially outward of the workpiece. The recess is partially filled with a porous material. Preferably, the recess is not completely filled with the porous material.

According to some embodiments, the porous material occupies only a radially outer portion of the recess, such that a radially inner portion of the recess is unoccupied by the porous material.

According to some embodiments, the porous material occupies only a lower portion of the recess, such that an upper portion of the recess is unoccupied by the porous material.

According to some embodiments, a top surface of the porous material is slanted downward from a radially inner portion of the recess to a radially outer portion of the recess.

According to some embodiments, an area of a surface of the containment member that faces the workpiece and contacts the immersion liquid is larger than an area of a surface of the workpiece that faces the containment member.

According to some embodiments, the projection apparatus further includes a servo mechanism connected to the containment member. The servo mechanism is configured to displace the containment member to compensate for a disturbance force acting on the workpiece table via the immersion liquid.

According to some embodiments, the servo mechanism compensates for the disturbance force by displacing the containment member in a direction along an optical axis of the optical assembly.

According to some embodiments, the porous material absorbs immersion liquid that contacts the porous material.

According to some embodiments, the liquid collection system further comprises a low pressure vacuum connected to the porous material that removes immersion liquid absorbed by the porous material.

According to some embodiments, a surface of the porous material is liquid-phyllic.

According to some embodiments, the containment member is a containment plate.

Other aspects of the invention relate to methods of manufacturing a device by performing immersion lithography using immersion lithography apparatus according to the various aspects and embodiments of the invention.

### BRIEF DESCRIPTION OF THE DRAWINGS

The invention will be described in conjunction with the following drawings of exemplary embodiments in which like reference numerals designate like elements, and in which:

FIG. 1 is a simplified elevational view schematically illustrating a lithographic projection apparatus according to one embodiment;

FIG. 2 is a plan view of a workpiece stage holding a workpiece, and shows a liquid collection system that surrounds the entire periphery of the workpiece held by the stage;

FIG. 3 is a simplified elevational view schematically illustrating a lithographic projection apparatus according to a second embodiment;

FIG. 4 is a simplified elevational view schematically illustrating a lithographic projection apparatus according to a third embodiment;

FIG. 5 is a simplified elevational view schematically illustrating a lithographic projection apparatus according to a fourth embodiment;

FIG. 6 is a simplified elevational view schematically illustrating a lithographic projection apparatus according to another embodiment;

FIG. 7 is a flowchart that outlines a process for manufacturing a device; and

FIG. 8 is a flowchart that outlines device processing in more detail.

### DETAILED DESCRIPTION OF EMBODIMENTS

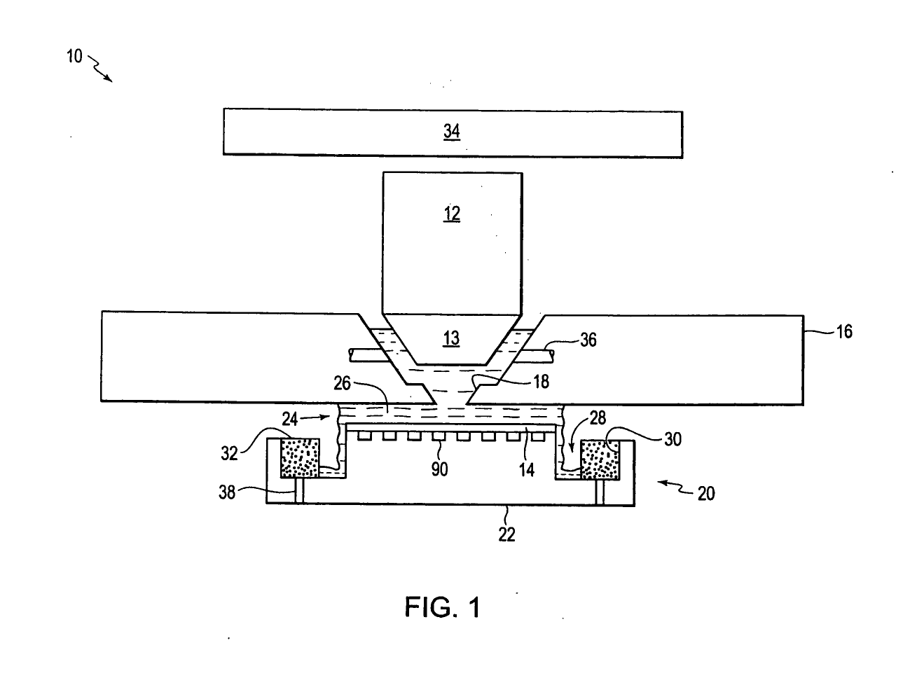

FIG. 1 shows a lithographic projection apparatus 10 including a reticle stage 34 on which a reticle is supported, an optical assembly 12 having a last or “final” optical element 13, and a workpiece 14 supported on a workpiece table 22, which in turn is movable by a movement stage (not shown), which are collectively referred to as stage assembly 20. The workpiece 14 may be vacuum chucked to the workpiece table 22 by use of a pin chuck or workpiece chuck 90. In addition, a porous chuck could be used. For example, the workpiece table 22 may include protrusions (not shown) such as pins, dimples or bumps that have upper surfaces that are precisely formed so as to exist in a plane and that engage the lower surface of the workpiece 14. A vacuum may be supplied through vacuum passages disposed either in the protrusions (opening through the top surface of the protrusions) or opening into the spaces between the protrusions so as to hold the workpiece 14 onto the workpiece table 22 by vacuum absorption. See US 2005/0219488 A1, which is incorporated herein by reference in its entirety, for an example of a workpiece holding member in which vacuum is supplied through openings in the upper surfaces of the protrusions (e.g., a “vacuum chuck”).

An immersion fluid supply and recovery apparatus 36, which is sometimes referred to herein as an immersion fluid supply and recovery nozzle, is disposed around the final optical element 13 of the optical assembly 12 so as to provide and recover an immersion fluid 26, which may be a liquid such as, for example, water, to/from a space 24 between the final optical element 13 and the workpiece 14. The exposure beam is modulated by the reticle or mask held by the reticle stage 34 so as to transfer an image of a pattern of the reticle onto the workpiece 14. The lithographic projection apparatus 10 also includes a containment member 16 disposed at a lower end of the optical assembly 12. The containment member 16 has an aperture 18 through which an exposure beam passes from the optical assembly 12 to the workpiece 14. See U.S. Ser. No. 11/907,218, which is incorporated herein by reference in its entirety, for an example of a containment plate. The stage assembly 20 includes a liquid collection system 28 that includes a recess 30 in the workpiece table 22. At least part of the recess is disposed radially outward of the workpiece 14. The liquid collection system 28 receives immersion liquid 26 that overflows the space 24 between the containment member 16 and the workpiece 14. As shown in FIG. 1, the recess 30 is partially filled with a porous material 32. One or more fluid recovery passages 38 are provided for the recess 30. The liquid collection system 28 is described below in further detail. In the present embodiment, the lithographic projection apparatus 10 is a scanning lithographic projection apparatus in which the reticle on reticle stage 34 and the workpiece 14 on stage assembly 20 are moved synchronously in respective scanning directions during a scanning exposure operation. The stage assembly 20 controls the position of the workpiece in one or more (preferably all) of the X, Y, Z, θX, θY and θZ directions with a high degree of precision. The stage assembly 20 also is used for moving the workpiece 14 over longer distances.

The illumination source of the lithographic projection apparatus 10 can be a light source such as, for example, a mercury g-line source (436 nm) or i-line source (365 μm), a KrF excimer laser (248 nm), an ArF excimer laser (193 nm) or a F₂ laser (157 nm). The optical assembly 12 projects and/or focuses the light passing through the reticle onto workpiece 14. Depending upon the design of the exposure apparatus, the optical assembly 12 can magnify or reduce the image illuminated on the reticle. The optical assembly 12 also could be a 1× magnification system.

When far ultraviolet radiation such as from the excimer laser is used, glass materials such as quartz and fluorite that transmit far ultraviolet rays can be used in the optical assembly 12. The optical assembly 12 can be catadioptric, completely refractive or completely reflective.

With an exposure device that employs radiation of wavelength 200 nm or less, use of the catadioptric type optical system can be considered. Examples of the catadioptric type of optical system are shown in U.S. Pat. No. 5,668,672 and U.S. Pat. No. 5,835,275. In these cases, the reflecting optical device can be a catadioptric optical system incorporating a beam splitter and concave mirror. U.S. Pat. No. 5,689,377 also uses a reflective-refracting type of optical system incorporating a concave mirror, etc., but without a beam splitter, and also can be employed with this invention. The disclosures of the above-mentioned U.S. patents are incorporated herein by reference in their entireties.

The immersion fluid supply and recovery apparatus 36 supplies immersion liquid 26 to the space 24 disposed between the last optical element 13 and the upper surface of the workpiece 14. The space 24 where the immersion liquid is supplied can be referred to as an immersion area. The immersion fluid supply and recovery apparatus 36 also collects immersion fluid 26 so that the immersion fluid 26 is continuously (or substantially continuously) supplied to and recovered from the immersion area so as to provide a flow of fresh immersion fluid to that area. The immersion fluid 26 is precisely temperature-controlled and filtered so as to remove particles and gas bubbles. Various structures can be provided as the immersion fluid supply and recovery apparatus 36. See, for example, US 2005/0219488 A1, US 2006/0023181 A1 and US 2006/0038968 A1, the disclosures of which are incorporated herein by reference in their entireties. The apparatus may be configured not to collect immersion fluid 26.

The containment member 16, which may be a containment plate, is sufficiently large to submerge the entire imaging surface of the workpiece 14 in the immersion fluid 26. For example, an area of a surface of the containment member 16 that faces the workpiece 14 and contacts the immersion liquid 26 may be larger than an area of a surface of the workpiece 14 that faces the containment member 16. As a result, the amount of immersion fluid 26 on the workpiece table 22 is much larger than in a conventional apparatus using a local fill process. A larger amount of immersion fluid 26 on the workpiece table 22 causes a greater force on the workpiece 14 due to the immersion fluid's larger mass and larger liquid meniscus. The various configurations of the liquid collection system 28 described herein minimize and/or compensate for the dynamic changes in the forces exerted on the workpiece table 22 by the larger mass and liquid meniscus of the immersion fluid 26. That is, the various configurations of the liquid collection system 28 minimize and/or compensate for the force variations resulting from changes in the shape of the liquid meniscus. Specifically, as shown in FIG. 1, the recess 30 is disposed in the workpiece table 22 adjacent to the radial periphery of the workpiece 14. That is, the radially inner wall of the recess 30 is disposed adjacent to the edge of the workpiece 14 such that the workpiece 14 does not extend past or over the radially inner wall of the recess 30. In other embodiments, the workpiece 14 may extend over the radially inner wall of the recess 30. Further, the edge of the workpiece 14 may extend to a distance shorter than the distance to the radially inner wall of the recess 30. The porous material 32 occupies only a radially outer portion of the recess 30, such that a radially inner portion of the recess 30 is unoccupied by the porous material 32. As a result, when the immersion liquid 26 is supplied to the space 24 between the final optical element 13 and the workpiece 14, the liquid meniscus of the immersion liquid 26 is disposed at the edge of the workpiece 14. Because the porous material 32 does not extend to the radially inner portion of the recess 30, the liquid meniscus does not contact the porous material 32, and thus the liquid meniscus is not affected by the porous material 32. Because the liquid meniscus is disposed at the edge of the workpiece 14, the immersion fluid 26 will fill the entire space 24 between the workpiece 14 and the containment member 16 before the immersion fluid 26 overflows into the recess 30. Accordingly, during workpiece scanning, the shape of the immersion liquid 26 (i.e., shape of the liquid body) is kept very similar to the shape of the workpiece 14, thereby minimizing force variation on the workpiece stage 22. In addition, the shape of the liquid meniscus does not change significantly. Therefore, position accuracy of the workpiece stage during exposure is improved. In conventional designs, the porous material around the workpiece is flush with the surface of the workpiece.

Further, by disposing the recess 30 at the radial periphery of the workpiece 14, immersion liquid 26 that flows beyond the edge of the workpiece 14 will tend to drop into the recess 30 rather than flow along the surface of the workpiece table 22. Immersion liquid 26 flowing beyond the edge of the workpiece 14 is undesirable because it may wet the under-surface of the workpiece 14, causing the workpiece 14 to stick to the workpiece table 22, making it difficult to remove the workpiece 14 from the workpiece table 22 when exposure is completed. Additionally, immersion liquid 26 that flows to the under-surface of the workpiece 14 can enter vacuum passages that are used to hold the workpiece 14 to the workpiece table 22, which is not desirable. Other undesirable effects include liquid damage to motors that move the workpiece 14, and liquid interfering with workpiece table 22 position sensors, which could cause a system crash.

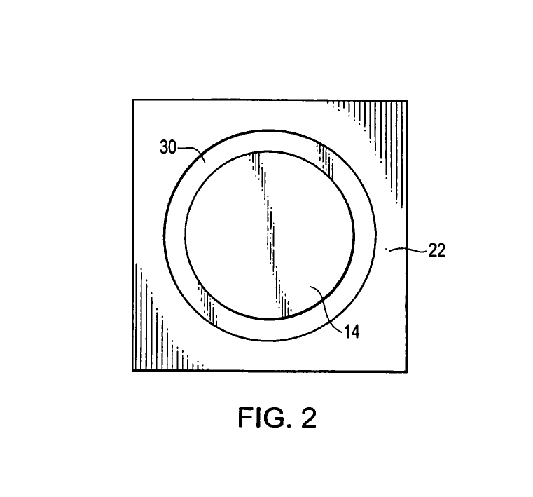

FIG. 2 shows the recess 30 of the liquid collection system 28 provided so as to extend around the entire periphery of the workpiece 14. As discussed above, the recess 30 is provided with a porous material or porous member 32. The porous material 32 may be an annular member having a predetermined width which is arranged around the workpiece 14. The porous material 32 absorbs immersion liquid 26 that contacts the porous material 32. The liquid collection system 28 also may include a low pressure vacuum (not shown) connected to the recess 30 containing the porous material 32 that removes immersion liquid 26 absorbed by the porous material 32. Further, a surface of the porous material 32 may be liquid-phyllic. The liquid-phyllic material allows easier flow of liquid through the porous material 32. The porous material 32 may a ceramic, metal or glass. As shown in FIG. 1, a fluid recovery passage 38 is formed in the recess 30. The fluid recovery passage 38 may be disposed at the bottom of the recess 30 and connected to the vacuum source, so as to draw immersion fluid 26 out of the porous material 32 and the recess 30.

The distance that the liquid collection system 28 extends away from the workpiece 14 edge (e.g., the width of the recess) depends on many factors including the amount of immersion liquid 26 that typically leaks from the immersion area, stage speed, acceleration, etc.

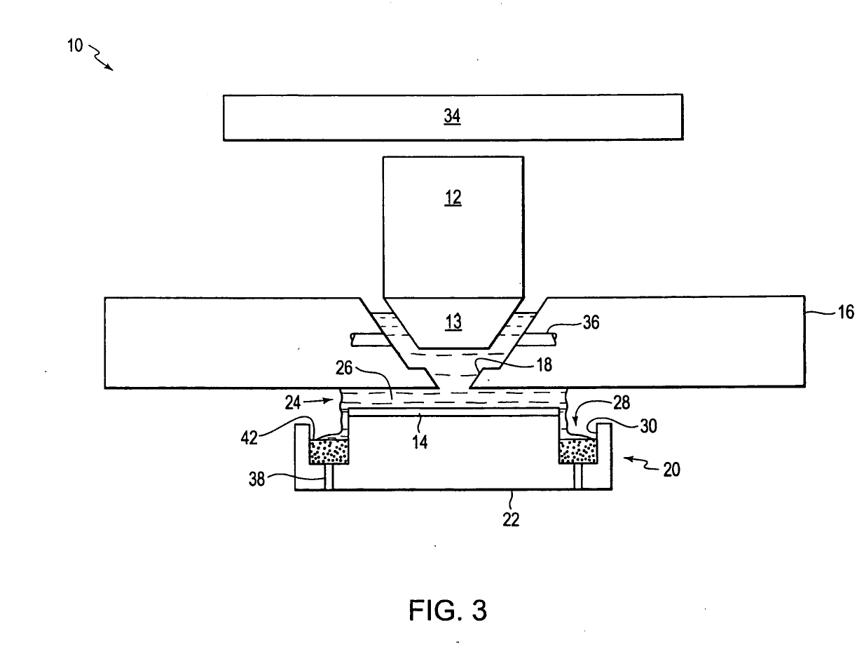

FIG. 3 shows a lithographic projection apparatus 10 according to a second embodiment. The second embodiment is similar to the first embodiment except for the disposition of the porous material 42 in the recess 30. The radially inner wall of the recess 30 is disposed adjacent to the edge of the workpiece 14 such that the workpiece 14 does not extend past or over the radially inner wall of the recess 30. In other embodiments, the workpiece 14 may extend over the radially inner wall of the recess 30. Further, the edge of the workpiece 14 may extend to a distance shorter than the distance to the radially inner wall of the recess 30. In the second embodiment, the porous material 42 occupies only a lower portion of the recess 30, such that an upper portion of the recess 30 is unoccupied by the porous material 42. That is, the porous material 42 is provided in the recess 30 below the periphery of the workpiece 14, at a certain distance below the lowermost surface of the workpiece 14. As discussed above, when the immersion liquid 26 is supplied to the space 24 between the final optical element 13 and the workpiece 14, the liquid meniscus of the immersion liquid 26 is disposed at the edge of the workpiece 14. Because the liquid meniscus is disposed at the edge of the workpiece 14, the immersion liquid 26 will fill the entire space 24 between the workpiece 14 and the containment member 16 before the immersion liquid 26 overflows into the recess 30. Accordingly, during workpiece scanning, the shape of the immersion liquid 26 (i.e., shape of the liquid body) is kept very similar to the shape of the workpiece 14, thereby minimizing force variation on the workpiece table 22. Therefore, position accuracy of the workpiece stage during exposure is improved. Further, by disposing the recess 30 at the radial periphery of the workpiece 14, immersion liquid 26 that flows beyond the edge of the workpiece 14 will tend to drop into the recess 30 rather than flow along the surface of the workpiece table 22, which would be undesirable for the reasons described above. The many features and alternatives of the first embodiment can be incorporated into the second embodiment.

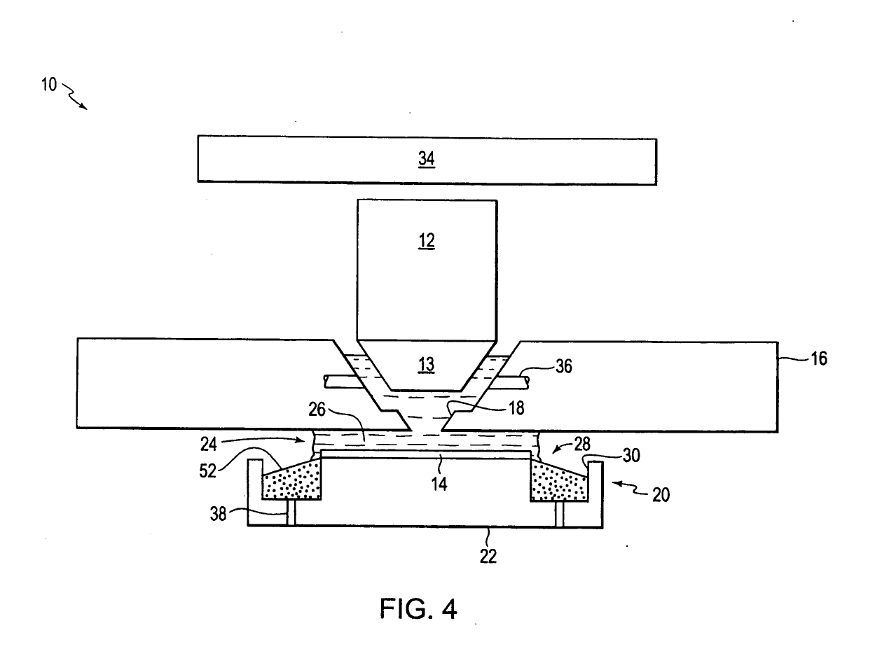

FIG. 4 shows a lithographic projection apparatus 10 according to a third embodiment. The third embodiment is similar to the first and second embodiments except for the disposition of the porous material 52 in the recess 30. The radially inner wall of the recess 30 is disposed adjacent to the edge of the workpiece 14 such that the workpiece 14 does not extend past or over the radially inner wall of the recess 30. In other embodiments, the workpiece 14 may extend over the radially inner wall of the recess 30. Further, the edge of the workpiece 14 may extend to a distance shorter than the distance to the radially inner wall of the recess 30. In the third embodiment, a top surface of the porous material 52 is slanted downward from the radially inner side of the recess 30 to the radially outer side of the recess 30. Because the top surface of the porous material 52 is slanted downward, immersion liquid 26 overflowing the space 24 between the final optical element 13 and the workpiece 14 will first fill the area above the porous material 52 on the radially inner side of the recess 30 before the area above the porous material 52 on the radially outer side of the recess 30. Thus, when the immersion liquid 26 is supplied to the space 24 between the final optical element 13 and the workpiece 14, the liquid meniscus of the immersion liquid 26 is disposed at the edge of the workpiece 14 at the area above the porous material 52 on the radially inner side of the recess 30. Because the liquid meniscus is disposed at the edge of the workpiece 14, the immersion fluid 26 will fill the entire space 24 between the workpiece 14 and the containment member 16 before the immersion fluid 26 overflows into the recess 30. As a result, the shape of the immersion liquid 26 (i.e., shape of the liquid body) can be controlled to be similar to the shape of the workpiece 14, thereby minimizing force variation on the workpiece table 22, by changing the slanted angle of the surface of the porous material 52. The many features and alternatives of the first and second embodiments can be incorporated into the third embodiment, where applicable.

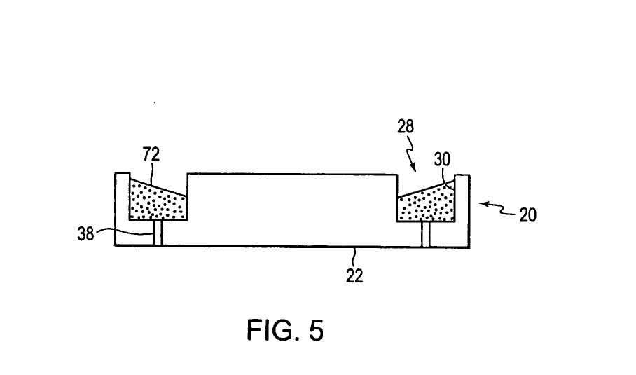

In a fourth embodiment, as shown in FIG. 5, a top surface of the porous material 72 is slanted downward from the radially outer portion of the recess 30 to the radially inner side of the recess 30.

A method of manufacturing a workpiece implements the features of the embodiments described above. For example, the method includes providing an immersion liquid 26 to a space 24 between an optical assembly 12 and a workpiece 14 supported on a workpiece table 22. The method also includes providing a containment member 16 at a lower end of the optical assembly 12, the containment member 16 including an aperture 18 through which an exposure beam passes from the optical assembly 12 to the workpiece 14. The method further includes providing the space 24 with the immersion liquid 26 extending between a surface of the workpiece 14 that receives the exposure beam and the containment member 16. The method also includes collecting immersion liquid 26 that overflows the space 24 between the containment member 16 and the workpiece 14 in a recess 30 provided in the workpiece table 22 disposed radially outward of the workpiece 14, the recess 30 including a porous material 32, 42, 52 that partially fills the recess 30. The method further includes exposing the workpiece 14 with the exposure beam.

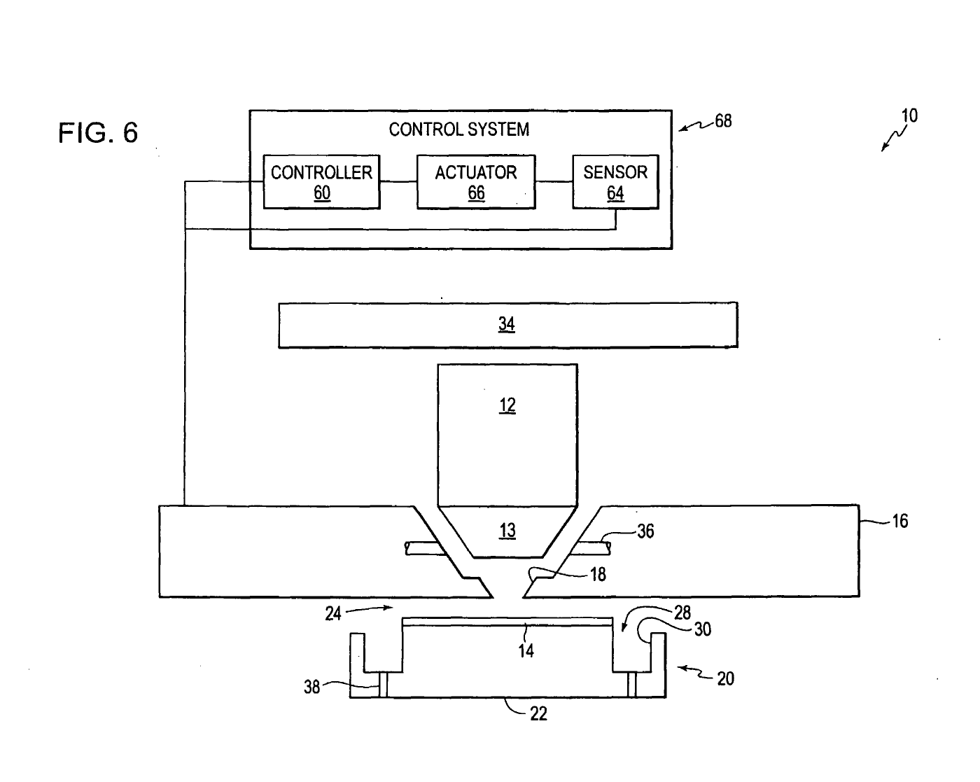

FIG. 6 shows a lithographic projection apparatus 10 according to another embodiment that includes a dynamic force control system 68. This further embodiment may incorporate the features and alternatives of any of the first through third embodiments described above. The control system 68 includes a controller 60, a sensor 64 and an actuator 66. The control system 68 may include more than one sensor 64 and actuator 66. The control system 68 is connected to the containment member 16, and is configured to displace the containment member 16 to compensate for a disturbance force acting on the workpiece table 22 via the immersion liquid 26. The containment member may be displaced in a direction along an optical axis of the optical assembly or about an axis that is perpendicular to an optical axis of the optical assembly. The disturbance force, or force variations, results from the large pressure forces caused by the relatively large shape/size of the body of the immersion liquid 26 generated by the containment member 16 submerging the entire imaging surface of the workpiece 14 in the immersion liquid 26. Disturbance forces may also result from various fluid properties and the surface properties of the workpiece 14, the containment member 16, and a workpiece coating, that contact the immersion liquid 26.

During operation, the sensor 64 measures pressure changes acting on the workpiece table 22. Specifically, the sensor 64 measures force variations or disturbance forces acting on the workpiece table 22 as a result of the containment member 16 submerging the entire imaging surface of the workpiece 14 in the immersion liquid 26. The sensor 64 sends the measured pressure readings to the controller 60. The controller 60 generates control signals that control the actuator 66 in response to the measured pressure readings. The actuator 66 operates to displace the containment member 16 to minimize and/or compensates for the force variations or disturbance force by displacing the containment member 16. For example, the containment member 16 may be displaced in a direction along an optical axis of the optical assembly 12 to minimize and/or compensates for the force variations or disturbance forces.

The sensor 64 used with the control system 68 may be a manometer, a capacitive manometer, a piezoelectric transducer or any other type of pressure sensor. The actuator 66 may include any device used to provide control of the desired displacement through the use of closed loop feedback, such as pistons, bellos, diaphragms and voice ciols.

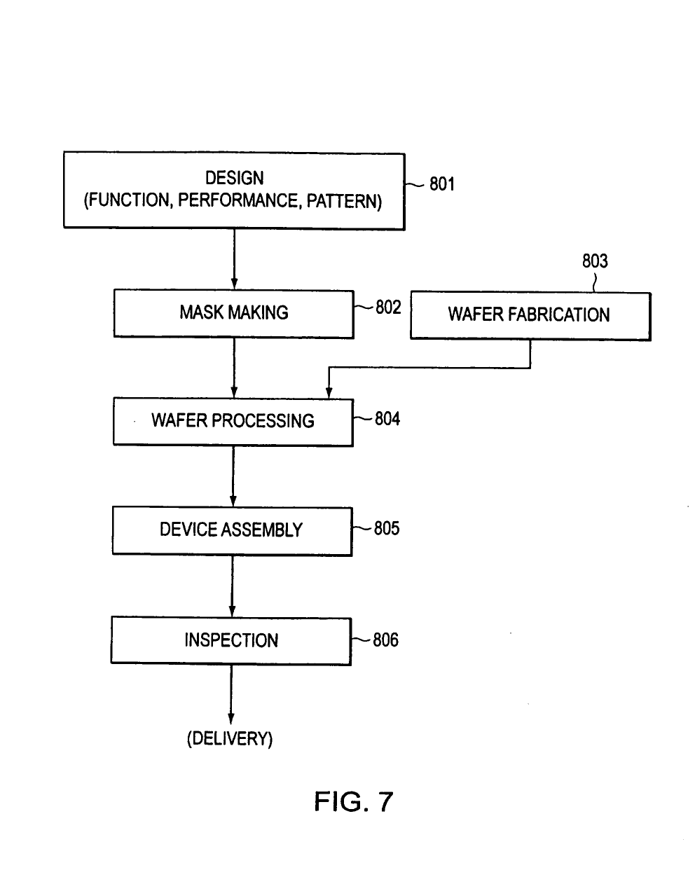

Semiconductor devices can be fabricated using the above described systems, by the process shown generally in FIG. 7. In step 801 the device's function and performance characteristics are designed. Next, in step 802, a mask (reticle) having a pattern is designed according to the previous designing step, and in a step 803, a wafer is made from a silicon material. The mask pattern designed in step 802 is exposed onto the wafer from step 803 in step 804 by a photolithography system described hereinabove in accordance with aspects of the invention. In step 805, the semiconductor device is assembled (including the dicing process, bonding process and packaging process). Finally, the device is then inspected in step 806.

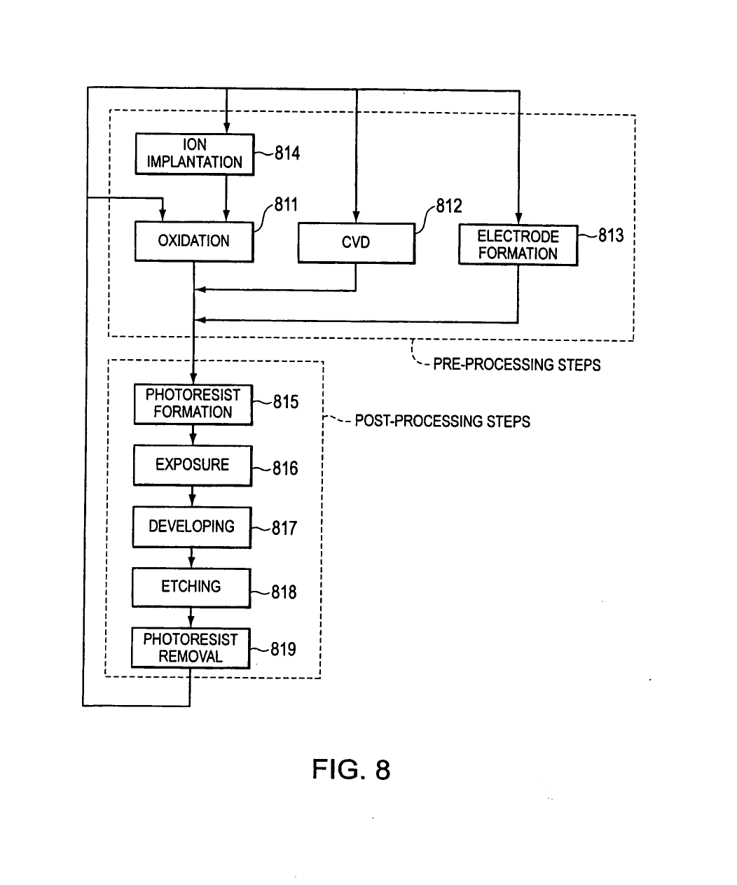

FIG. 8 illustrates a detailed flowchart example of the above-mentioned step 804 in the case of fabricating semiconductor devices. In FIG. 8, in step 811 (oxidation step), the wafer surface is oxidized. In step 812 (CVD step), an insulation film is formed on the wafer surface. In step 813 (electrode formation step), electrodes are formed on the wafer by vapor deposition. In step 814 (ion implantation step), ions are implanted in the wafer. The above mentioned steps 811-814 form the preprocessing steps for wafers during wafer processing, and selection is made at each step according to processing requirements.

At each stage of wafer processing, when the above-mentioned preprocessing steps have been completed, the following post-processing steps are implemented. During post-processing, first, in step 815 (photoresist formation step), photoresist is applied to a wafer. Next, in step 816 (exposure step), the above-mentioned exposure device is used to transfer the circuit pattern of a mask (reticle) to a wafer. Then in step 817 (developing step), the exposed wafer is developed, and in step 818 (etching step), parts other than residual photoresist (exposed material surface) are removed by etching. In step 819 (photoresist removal step), unnecessary photoresist remaining after etching is removed. Multiple circuit patterns are formed by repetition of these preprocessing and post-processing steps.

An immersion lithography apparatus (an exposure apparatus) according to the embodiments described herein can be built by assembling various subsystems in such a manner that prescribed mechanical accuracy, electrical accuracy, and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into an immersion lithography apparatus includes providing mechanical interfaces, electrical circuit wiring connections and air pressure plumbing connections between each subsystem. Each subsystem also is assembled prior to assembling an immersion lithography apparatus from the various subsystems. Once an immersion lithography apparatus is assembled using the various subsystems, a total adjustment is performed to make sure that accuracy is maintained in the complete immersion lithography apparatus. Additionally, it is desirable to manufacture an exposure system in a clean room where the temperature and cleanliness are controlled.

While the invention has been described with reference to preferred embodiments thereof, it is to be understood that the invention is not limited to the preferred embodiments or constructions. The invention is intended to cover various modifications and equivalent arrangements. In addition, while the various elements of the preferred embodiments are shown in various combinations and configurations, that are exemplary, other combinations and configurations, including more, less or only a single element, are also within the spirit and scope of the invention.

What is claimed is:

1. A lithographic projection apparatus comprising:
an optical assembly that projects an image onto a workpiece;
a containment member disposed adjacent to a lower end of the optical assembly, the containment member having an aperture through which an exposure beam passes from the optical assembly to the workpiece;
a stage assembly including a workpiece table that supports the workpiece adjacent to the containment member, a space between the containment member and the workpiece being filled with an immersion liquid; and
a liquid collection system including a recess in the workpiece table that receives immersion liquid that overflows the space between the containment member and the workpiece,
wherein at least part of the recess is disposed radially outward of the workpiece and the recess is partially filled with a porous material.

2. The apparatus of claim 1, wherein the porous material occupies only a radially outer portion of the recess, such that a radially inner portion of the recess is unoccupied by the porous material.

3. The apparatus of claim 1, wherein the porous material occupies only a lower portion of the recess, such that an upper portion of the recess is unoccupied by the porous material.

4. The apparatus of claim 1, wherein a top surface of the porous material is slanted downward from a radially inner portion of the recess to a radially outer portion of the recess.

5. The apparatus of claim 1, wherein an area of a surface of the containment member that faces the workpiece and contacts the immersion liquid is larger than an area of a surface of the workpiece that faces the containment member.

6. The apparatus of claim 1, further comprising:
a servo mechanism connected to the containment member, the servo mechanism configured to displace the containment member to compensate for a disturbance force acting on the workpiece table via the immersion liquid.

7. The apparatus of claim 6, wherein the servo mechanism compensates for the disturbance force by displacing the containment member in a direction along an optical axis of the optical assembly.

8. The apparatus of claim 6, wherein the servo mechanism compensates for the disturbance force by displacing the containment member about an axis that is perpendicular to an optical axis of the optical assembly.

9. The apparatus of claim 1, wherein the porous material absorbs immersion liquid that contacts the porous material.

10. The apparatus of claim 9, wherein the liquid collection system further comprises a low pressure vacuum connected to the porous material that removes immersion liquid absorbed by the porous material.

11. The apparatus of claim 1, wherein a surface of the porous material is liquid-phyllic.

12. The apparatus of claim 1, wherein the containment member is a containment plate.

13. A device manufacturing method comprising:
providing an immersion liquid to a space between an optical assembly and a workpiece supported on a workpiece table, a containment member being disposed adjacent to a lower end of the optical assembly, the containment member including an aperture through which an exposure beam passes from the optical assembly to the workpiece, the space that is provided with the immersion liquid extending between a surface of the workpiece that receives the exposure beam and the containment member;
collecting immersion liquid that overflows the space between the containment member and the workpiece in a recess provided in the workpiece table, at least part of the recess being disposed radially outward of the workpiece, and the recess including a porous material that partially fills the recess; and
exposing the workpiece with the exposure beam.

14. The method of claim 13, further comprising:
filling only a radially outer portion of the recess with the porous material, such that a radially inner portion of the recess is unoccupied by the porous material.

15. The method of claim 13, further comprising:
filling only a lower portion of the recess with the porous material, such that an upper portion of the recess is unoccupied by the porous material.

16. The method of claim 13, further comprising:
filling the recess with the porous material so that a top surface of the porous material is slanted downward from a radially inner portion of the recess to a radially outer portion of the recess.

17. The method of claim 13, wherein an area of a surface of the containment member that faces the workpiece and contacts the immersion liquid is larger than an area of a surface of the workpiece that faces the containment member.

18. The method of claim 13, further comprising:
displacing the containment member to compensate for a disturbance force acting on the workpiece table via the immersion liquid.

19. The method of claim 18, further comprising:
displacing the containment member in a direction along an optical axis of the optical assembly.

20. The method of claim 18, further comprising:
displacing the containment member about an axis that is perpendicular to an optical axis of the optical assembly.

21. The method of claim 13, further comprising:
absorbing immersion liquid that contacts the porous material.

22. The method of claim 21, further comprising:
removing immersion liquid absorbed by the porous material by applying a vacuum to the porous material.

23. The method of claim 13, wherein a surface of the porous material is liquid-phyllic.

24. The method of claim 13, wherein the containment member is a containment plate.
